(19) United States
(12) Patent Application Publication
(10) Pub. No.: US 2008/0264258 A1
(43) Pub. Date: Oct. 30, 2008

(54) Filter for Removing of Physical and/or Biological Impurities

(75) Inventors: Ladislav Mares, Liberec (CZ); David Petras, Peroltice (CZ); Petr Kuzel, Liberec (CZ)

Correspondence Address: DORITY & MANNING, P.A., POST OFFICE BOX 1449, GREENVILLE, SC, 29602-1449, US

(73) Assignee: EL-MARCO, S.R.O., Liberec (CZ)

(21) Appl. No.: 12/093,141

(22) PCT Filed: Nov. 2, 2006
(86) PCT No.: PCT/CZ06/00077

§ 371 Date: May 9, 2008

(30) Foreign Application Priority Data
Nov. 10, 2005 (CZ) PV 2005-700

(51) Int. Cl. B01D 53/04; B01D 39/16

(52) U.S. Cl. 96/131

(57) ABSTRACT

The invention relates to the filter for removing of physical and/or biological impurities from the filtrated media containing the textile fibres. The filter contains at least one couple (L) of nanofibrous layers, out of which in the direction of passage of the filtrated media the first nanofibrous layer is an active nanofibrous layer (2) formed of polymeric nanofibres containing particles of at least one low molecular substance active against the removed biological impurity or removed biological impurities, and the second nanofibrous layer is represented by the filtration nanofibrous layer (3) formed of polymeric nanofibres, while the size of gaps for passage of filtrated media between nanofibres of the filtration nanofibrous layer (3) is smaller than the size of gaps for passage of filtrated media between nanofibres of active nanofibrous layer (2) and smaller than the size of elements of biological impurity or biological impurities removed by means of this filtration nanofibrous layer (3). Next to this the invention relates to the air filter and water filter and to the face screen for protection against biological impurities.

### TECHNICAL FIELD

The invention relates to the filter for removing of physical and/or biological impurities from the filtrated media containing the textile fibres.

Next to this the invention relates to the air filter containing textile fibres for removing of physical and/or biological impurities from the filtrated air.

The invention relates also to the face screen containing inner textile layer and outer textile layer for removal of physical and/or biological impurities from the breathed in and breathed out air.

The invention also relates to the water filter containing the sand filter of variable size of particles for removing of physical and/or biological impurities from the filtrated water.

### BACKGROUND ART

In the surrounding air, which we are breathing in, not only due to industrial manufacturing or ecological disasters there is relatively high quantity of dust, harmful chemicals and also a large spectrum of micro-organisms, which as the originators of many bacterial or virus diseases are harmful for human organism.

At present there is known a large quantity of various types of screens, respirators, gas masks, filters and similar equipment for cleaning of breathed in air, while the entire majority of the known solutions of these means concentrates first of all to removing of dust particles from the inhaled air. Their principle consists especially in creation of more or less complex labyrinth (e.g. of fibres) so that there is the highest possible probability that the dust particles or similar corpuscular impurities are caught.

To remove the harmful chemicals, combat gases and for example also unpleasant odours, the above mentioned means are added by one or more layers created by or containing an active carbon in various forms. For the reason to enlarge or increase efficiency of these means the layer of active carbon is usually completed by another chemical substance, which forms a coating of particles of active carbon or is filling the space between them.

For example from the U.S. Pat. No. 5,714,126 there is known the filtration system of respirator, which contains one layer of active carbon and a second layer of active carbon which differs from the first one by the fact that the particles of active coal are coated by a layer of sulphate, molybdenum or of a similar substance.

The disadvantage of such designed means nevertheless is that in spite of their relative complicated structure they mostly do not act on micro-organisms being present in the passing air and these after then easily penetrate into the airways of the user, possibly they are caught in the structure of the said means, where they quietly exist and they may, even after a relatively long time since bringing the first micro-organisms, become a source of infection or contamination.

According to several known solutions, to prevent the transmission of unwilling micro-organisms through the filtration means of the breathed in air possibly their survival there is created a new layer provided with an anti-microbial substance or some of the existing layers of the filtration means is supplemented by such a substance. The mentioned anti-microbial substance liquidates or at least markedly weakens the incoming micro-organisms, in a more or less reliable manner.

Due to the fact that to the substances with the most effective anti-microbial effect with nearly unlimited sphere of action belongs silver, both in the ionic or metal form, several solutions of filtration means incorporate the particles or fibres of silver, possibly of it compounds.

For example the WO 2005002675 describes the nose mask, whose component part is a “pocket” with small holes, where the fibres of silver or tourmaline particles are positioned, which render to this mask the antimicrobial properties, when they with their presence bind and destroy the unwilling micro-organisms.

The disadvantage of this one and of most of other solutions relating to the means for removal of micro-organisms containing silver is first of all relatively complicated production of these means, which nearly always includes the necessity to produce the body of the mask separately and the antimicrobial substance separately, e.g. the silver fibres or particles, only after which assembling of the final product follows.

The similar status exists in the field of air cleaning in air conditioning circuits, both in buildings or vehicles. At the same time there are known applications using the textile fibres containing silver that make use of antimicrobial effects of silver to prevent reproducing of microbes and of other biological impurities in textile products, e.g. in socks or towels.

Known is also usage of silver upon cleaning of water from biological impurities, nevertheless this method is relatively costly and complicated. Therefore chlorination is used upon cleaning of water from biological impurities in most cases.

From the studies of colloidal status of the substance it is more over known that the chemical, possibly catalytic action of solid substances is being increased with specific surface of the active substances. When the size of particles of the active substance in the carrier is decreasing, it is possible to reach the required rate of effect through a less quantity of active substance in the carrier, or through a lower concentration of the active substance in the carrier.

The objective of the invention is to eliminate or at least to minimise the disadvantages of the present state of the art and simultaneously to make use of the knowledge as regards the possibility to reduce the size of particles of active substances.

### The Principle of Invention

The objective of the invention has been reached through a filter which contains at least one couple of nanofibrous layers, out of which in the direction of passage of the filtrated media the first nanofibrous layer is an active nanofibrous layer formed of polymeric nanofibres containing particles of at least one low molecular substance active against the removed biological impurity or removed biological impurities and the second nanofibrous layer is represented by the filtration nanofibrous layer formed of polymeric nanofibres, while the size of gaps for passage of filtrated media between nanofibres of the filtration nanofibrous layer is smaller than the size of gaps between nanofibres of active nanofibrous layer and smaller than the size of elements of biological impurity or biological impurities removed by means of this filtration nanofibrous layer.

The advantage of the filter containing at least one couple of nanofibrous layers according to the invention consists especially in that the biological impurities caught by the filtration nanofibrous layer are killed or at least weakened through a contact with low-molecular substance active against the biological impurity or impurities being removed which is contained in nanofibres of the active nanofibrous layer. The biological impurities being removed, after being caught by the filtration nanofibrous layer, are then held in the active nanofibrous layer in which is upon them acting the respective active substance, which is a part of nanofibres of the active nanofibrous layer.

To extend the efficiency of the filter it is advantageous if it contains at least two couples of nanofibrous layers, out of which each is determined for catching and liquidation of different biological impurity or different biological impurities, while in the direction of passage of the filtrated media the individual couples of nanofibrous layers have smaller size of gaps for passage of media being filtrated and each consequent couple of nanofibrous layers is determined for catching and liquidation of smaller biological impurities than the previous couples of nanofibrous layers.

Reduction in number of nanofibrous layers of the filter upon preservation of its efficiency is reached according to the claim 3. The filtration nanofibrous layer of the previous couple of nanofibrous layers creates the active nanofibrous layer of the following couple of nanofibrous layers, while it is formed of nanofibres containing at least one low molecular substance effectively acting against biological impurities being caught by a filtration nanofibrous layer of the following couple of nanofibrous layers.

In an advantageous embodiment of filter in the direction of passage of the media being filtrated the first couple of nanofibrous layers is determined for catching and liquidation of bacteria and in the direction of passage of the media being filtrated the second couple of nanofibrous layers is determined for catching and liquidation of viruses. This splitting is advantageous in part due to different size of particles of biological impurities being caught and simultaneously for selection of suitable low molecular substance effectively acting against biological impurities being caught.

At the above mentioned solution it is advantageous if the filtration nanofibrous layer of the first couple of nanofibrous layers is formed of nanofibres, between which there are gaps for passage of media being filtrated smaller than the size of the smallest bacteria which should be caught by this filtration nanofibrous layer, and the active nanofibrous layer of the first couple of nanofibrous layers is formed of nanofibres containing at least one bactericidal low molecular substance effectively acting against bacteria being caught by a respective filtration nanofibrous layer, at the same time the filtration nanofibrous layer of the second couple of nanofibrous layers is formed of nanofibres, between which the gaps for passage of media being filtrated are smaller than the size of viruses, which should be caught by this filtration nanofibrous layer, and an active nanofibrous layer of the second couple of nanofibrous layers is formed of nanofibres containing at least one virucidal substance effectively acting against viruses being caught by the filtration nanofibrous layer of the second couple of nanofibrous layers. Splitting of couples of nanofibrous layers according to size of particles being caught and liquidated of biological impurities enables also the targeted action upon certain bacteria selected according to their size one after another arranged couples of nanofibrous layers.

The gaps for passage of media being filtrated between nanofibres of the filtration nanofibrous layer of the first couple of nanofibrous layers are from 300 to 700 nm, which enables catching of bacteria creating the biological impurities being removed, as the size of bacteria varies from 350 to 1000 nm.

The gaps for passage of media being filtrated between nanofibres of the filtration nanofibrous layer of the second couple of nanofibrous layers are from 50 to 200 nm. This arrangement enables catching of a large portion of viruses whose characteristic size varies from 10 to 150 nm. Catching of viruses of a size under 50 nm from the point of view of present state of the art seams to be problematic due to a difficult clearness of filtration nanofibrous layer with gaps for passage of media being filtrated between nanofibres under 10 nm. Nevertheless this solution is not excluded upon achievement of the thickness of produced nanofibres in units of nanometers with maximum thickness of nanofibres in the layer in the place value of several tens of nanometers.

Surface weight of nanofibrous layers at all above mentioned embodiments varies with advantage in an interval from 0.1 to 0.3 g/m², while the filtration nanofibrous layer of a respective couple of nanofibrous layers has a smaller surface weight than in the direction of passage of the media being filtrated before it positioned active nanofibrous layer of the respective couple of nanofibrous layers. This arrangement ensures a sufficient permeability of nanofibrous layers for medium being filtrated.

Polymeric nanofibres of filtration nanofibrous layers are produced through an electrostatic spinning of polymeric solution and polymeric nanofibres of active nanofibrous layers are produced through electrostatic spinning of polymeric solution containing the particles of respective low molecular substance or a substance out of which after spinning the particles of respective low molecular substance are created through some of known methods. This way of production of nanofibres for nanofibrous layers of a filter according to the invention seems to be the most advantageous as at this method the fineness of nanofibres as well as the content and size of particles of low molecular substances which are deposited in them, can be affected to a broad extent.

The low molecular substances applied in active nanofibrous layers of filters according to the invention are selected according to the bacteria, virus or other micro-organism which should be liquidated in the corresponding layer. The mostly used low molecular substances applied against the biological impurity being removed are the low molecular substances from the group of silver in a metallic form, compounds of silver, quaternary ammonia salts and PVP iodine.

Diameters of nanofibres vary in the range from 50 to 700 nm, while for preservation of a sufficient permeability of nanofibrous layers the diameter of nanofibres in individual nanofibrous layers in the direction of passage of media being filtrated in each consecutive nanofibrous layer is decreasing with decreasing size of gaps for passage of media being filtrated between the nanofibres. Simultaneously with this, with advantage, the surface weight of corresponding nanofibrous layer is also decreasing.

The particles of used low molecular substances are, as mentioned already before, deposited and fixed in polymeric nanofibre, at the same time it is advantageous, if the characteristic size of particles of low molecular substance or low molecular substances in nanofibres of active nanofibrous layers lies in the range from 5 to 100 nm, while the size of particles corresponds also to the diameters of nanofibres.

The above described filters are designated for filtration of gases and liquids, out of which it is necessary to remove not only physical impurities but especially biological impurities, and therefore the most frequent media being filtrated is air or water.

The principle of air filter according to the invention lies in that it contains at least one couple of nanofibrous layers, out of which in the direction of passage of filtrated air the first layer is the active nanofibrous layer formed of polymeric nanofibres containing particles of at least of one low molecular substance effective against biological impurity being removed or biological impurities being removed, and the second layer is the filtration nanofibrous layer formed of polymeric nanofibres, while the size of gaps for passage of air being filtrated between nanofibres of filtration nanofibrous layer are smaller than is the size of gaps for passage of filtrated air between nanofibres of active nanofibrous layer, and simultaneously it is smaller than the size of particles of biological impurity being removed or biological impurities being removed.

The invention also relates to the face screen for removing of physical and/or biological impurities from the breathed in or breathed out air, which contains the outer and inner textile layer, while the principle of the invention lies in that between the outer textile layer and the inner textile layer there is arranged a couple of nanofibrous layers containing the filtration nanofibrous layer with gaps between the nanofibres to 300 nm, and according to the designation of the face screen in the direction of air passage before the filtration nanofibrous layer there is arranged active nanofibrous layer formed of polymeric nanofibres containing particles of at least one bactericidal low molecular substance. The face screen is able to catch the physical impurities and to catch and liquidate the biological impurities formed of bacteria. At the same time it may be arranged for protection of a man being in a biologically polluted surroundings before ambient biological impurities or for prevention of breathing out of biological impurities, e.g. for protection of a patient before the biological impurities breathed out by neighbouring people.

Filtration nanofibrous layer of face screen for protection of a man before the ambient biological impurities is arranged in the direction of breathing in before the inner textile layer and between the filtration nanofibrous layer formed of polymeric nanofibres and outer textile layer there is arranged an active nanofibrous layer formed of polymeric nanofibres with particles of at least one low molecular bactericidal substance, which are contained in the nanofibres of active nanofibrous layer.

The filtration nanofibrous layer of a surgical face screen for protection of breathing out of biological impurities is arranged in the direction of breathing out before the outer textile layer and between this filtration nanofibrous layer created by polymeric nanofibres and inner textile layer there is arranged an active nanofibrous layer formed of polymeric nanofibres with particles of at least one low molecular bactericidal substance, which are contained in nanofibres of active nanofibrous layer.

The face screen for protection of breathing in and breathing out of biological impurities contains two couples of nanofibrous layers which are facing one another with their filtration nanofibrous layers.

At the same time it is advantageous when both couples of nanofibrous layers have a common filtration nanofibrous layer.

In an advantageous embodiment of the face screen for protection against bacteria, the gaps for passage of an air between the nanofibres of the filtration nanofibrous layer are from 300 to 700 nm, while the gaps between nanofibres of active nanofibrous layer are greater.

The face screen for protection against bacteria and viruses contains virucidal couple of nanofibrous layers arranged in the direction of passage of air behind bactericidal couple of nanofibrous layers, while the filtration nanofibrous layer of virucidal couple of nanofibrous layers has gaps for passage of air between nanofibres from 50 to 200 nm, and in the direction of air passage before the filtration nanofibrous layer of virucidal couple of nanofibrous layers, there positioned active nanofibrous layer is formed of nanofibres containing the particles of virucidal substance.

At the same time it is advantageous, if gaps between nanofibres of active nanofibrous layer of virucidal couple of nanofibrous layers are greater than gaps between nanofibres of filtration nanofibrous layer of virucidal couple of nanofibrous layers and at the same time smaller than gaps between nanofibres of filtration nanofibrous layers of bactericidal couple of nanofibrous layers.

The principle of the water filter according to the invention lies in that behind the sand filter there is arranged at least one couple of nanofibrous layers, out of which in the direction of passage of water being filtrated the first nanofibrous layer is an active nanofibrous layer formed of polymeric nanofibres containing the particles at least of one low molecular substance active against the biological impurity being removed or the biological impurities being removed, and the second nanofibrous layer is the filtration nanofibrous layer formed of polymeric nanofibres, while the size of gaps for passage of filtrated water between the nanofibres of filtration nanofibrous layer is smaller than the size of gaps for passage of filtrated water between the nanofibres of active nanofibrous layer and simultaneously smaller than the size of particles of biological impurity being removed or biological impurities being removed.

### DESCRIPTION OF THE DRAWING

The examples of embodiment of the invention are schematically illustrated in enclosed drawings where the

FIG. 1 shows the filter containing one couple of nanofibrous layers with marked direction of flowing of the media filtrated, the

FIG. 2 the filter containing two couples of nanofibrous layers, the

FIG. 3 the filter containing two couples of nanofibrous layers which have one nanofibrous layer that is common, the

FIG. 4 a section through an air filter with marked direction of air flow, the

FIG. 5 shows a simplified section through the water filter, the

FIG. 6a a simplified partial cross section of the face screen containing one couple of nanofibrous layers with marked direction of air flow during breathing in, the

FIG. 6b a simplified partial section through the face screen containing one couple of nanofibrous layers with marked direction of air flow during breathing out, the

FIG. 6c simplified partial section through the face screen containing two couples of nanofibrous layers for prevention of breathing in and breathing out of biological impurities, the

FIG. 6d the simplified partial section through the face screen containing two couples of nanofibrous layers with one common filtration nanofibrous layer, the

FIG. 7 simplified partial section through the face screen containing two couples of nanofibrous layers with one nanofibrous layer that is common, and the

FIG. 8 shows simplified partial section through a face screen containing two couples of nanofibrous layers.

### EXAMPLES OF EMBODIMENT

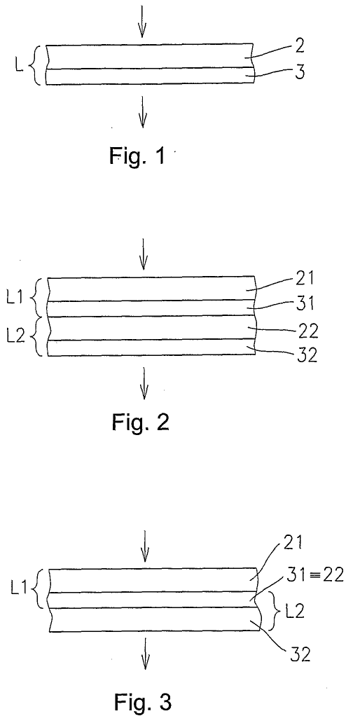

The filter for removal of physical and/or biological impurities from the media being filtrated containing textile fibres contains in the example of embodiment according to the FIG. 1 one couple L of nanofibrous layers out of which, in the direction of passage of the media being filtrated, the first nanofibrous layer is an active nanofibrous layer 2 created from polymeric nanofibres containing the particles of at least one low molecular substance effective against the biological impurity being removed or biological impurities being removed. In the direction of passage of the media filtrated through the couple L of nanofibrous layers the second nanofibrous layer is the filtration nanofibrous layer 3 formed of polymeric nanofibres, while the size of gaps for passage of media being filtrated between the nanofibres of the filtration nanofibrous layer 3 is smaller that the size of gaps for passage of media being filtrated between the nanofibres of an active nanofibrous layer 2 and smaller than the size of particles of biological impurity or biological impurities being removed through this filtration nanofibrous layer 3.

The FIG. 2 shows an example embodiment of filter for removal of physical and/or biological impurities, which contains two couples L1, L2 of nanofibrous layers out of which each is determined for catching and liquidation of different biological impurity or different biological impurities. The filtration nanofibrous layer 31 of the first couple L1 of nanofibrous layers is formed of nanofibres between which there are gaps for passage of media being filtrated smaller than is the size of the smallest bacteria which should be caught by this nanofibrous layer 31, and an active nanofibrous layer 21 of the first couple L1 of nanofibrous layers is created from nanofibres containing at least one bactericidal low molecular substance effectively acting against bacteria caught by a respective filtration nanofibrous layer 31. The filtration nanofibrous layer 32 of the second couple L2 of nanofibrous layers is formed of nanofibres, among which there are gaps for passage of media being filtrated smaller than the size of viruses which should be by this filtration nanofibrous layer 32 caught, and the active nanofibrous layer 22 of the second couple L2 of nanofibrous layers is formed of nanofibres containing at least one virucidal substance effectively acting against viruses being caught by a filtration nanofibrous layer 32 of the second couple L2 of nanofibrous layers. The filtration nanofibrous layer 32 and the active nanofibrous layer 22 of the second couple L2 of nanofibrous layers may also serve for catching and liquidation of bacteria of smaller dimensions than the bacteria caught and liquidated by the first couple L1 of nanofibrous layers.

Therefore, if two couples L1, L2 of nanofibrous layers are used, the size of gaps between nanofibres of individual in the direction of passage of media being filtrated one after another following nanofibrous layers 21, 31, 22, 32 is decreasing gradually. The largest gaps between the nanofibres are then in the active nanofibrous layer 21 of the first couple L1 of nanofibrous layers. Smaller gaps between the nanofibres are in the filtration nanofibrous layer 31 of the first couple L1 of nanofibrous layers, which serves for catching of the largest selected micro-organisms, that usually are the bacteria. Yet smaller gaps between nanofibres are in the active nanofibrous layer 22 of the second couple L2 of nanofibrous layers and the smallest gaps between nanofibres are in the filtration nanofibrous layer 32 of the second couple L2 of nanofibrous layers. In the not illustrated case there are used other couples L1 of nanofibrous layers, containing active nanofibrous layer 2i and the filtration nanofibrous layer 3i.

The dimensions of bacteria vary in an interval from 350 to 1000 nm. Therefore for catching even the smallest bacteria it is sufficient if there are created gaps between nanofibres of the respective filtration nanofibrous layer having dimensions up to 300 nm. The characteristic dimension of viruses varies from 10 to 200 nm. Due to the fact that by means of current methods of electrostatic spinning of polymer solutions at present the nanofibrous textiles with gaps between nanofibres from 50 nm and higher can be produced, the viruses greater than 50 nm from the shown range of viruses can be caught by the filtration nanofibrous layer. To be able to catch viruses in the whole range of their dimensions, it is necessary to produce the filtration nanofibrous layer with gaps for passage of media being filtrated between nanofibres smaller than 10 nm, this means e.g. 6 to 9 nm. To keep the permeability of such a filtration nanofibrous layer for the media being filtrated, the diameters of nanofibres are in units or tens of nanometers, while as optimum thickness of nanofibres seems to be in the range from 10 to 30 nm. Such filtration nanofibrous layer can be produced through the technology of electrostatic spinning of solutions of polymers.

The FIG. 3 shows an example embodiment of filter for removing of physical and/or biological impurities, which contains two couples L1, L2 of nanofibrous layers, out of which each is designated for catching and liquidation of a different biological impurity or of different biological impurities. Filtration nanofibrous layer 31 of the first couple L1 of nanofibrous layers at the same time represents an active nanofibrous layer 22 of the second couple L2 of nanofibrous layers and it is formed of nanofibres containing at least one low molecular substance effectively acting against the biological impurities being caught by the filtration nanofibrous layer of the second couple L2 of nanofibrous layer. The gaps for passage of media being filtrated between nanofibres of the corresponding filtration nanofibrous layer 31, 32 are created according to the size of particles of biological impurity or biological impurities which should be caught by the filtration nanofibrous layer 31, 32 and according to the biological impurity or composition of biological impurities, which should be caught by a corresponding filtration nanofibrous layer 31, 32 the effective low molecular substance is selected, which is contained in nanofibres of the respective active nanofibrous layer 21, 22.

The gaps for passage of media being filtrated between nanofibres of the filtration nanofibrous layer 3 or 31 of a single couple L or the first couple L1 of nanofibrous layers designated for catching and liquidation of bacteria are from 300 to 700 nm according to the size of bacteria which should be caught.

The gaps for passage of media being filtrated between nanofibres of the filtration nanofibrous layer 32 of the second couple L2 of nanofibrous layers designated for catching and liquidation of viruses are from 50 to 200 nm according to the size of viruses which should be caught.

The surface weight of nanofibrous layers varies in an interval from 0.1 to 0.3 g/m², while the filtration nanofibrous layer 3, 31, 32 of the corresponding couple L, L1, L2 of nanofibrous layers has a smaller surface weight than in the direction of passage of filtrated media before it positioned active nanofibrous layer 2, 21, 22 of the corresponding couple L, L1, L2 of nanofibrous layers.

Polymeric nanofibres of filtration nanofibrous layers 3, 31, 32 are produced through electrostatic spinning of polymeric solution and polymeric nanofibres of active nanofibrous layers 2, 21, 22, are produced through electrostatic spinning of polymeric solution containing particles of corresponding low molecular substance or a substance out of which after spinning the particles of corresponding low molecular substance in nanofibres are produced through some of known methods.

Low molecular substance active against bacteria is the low molecular substance from the group of silver in a metallic form, compounds of silver, e.g. salts of silver and quaternary ammonia salts. Low molecular substance active against viruses are e.g. PVP iodine, possibly other known low molecular substances active against viruses.

Diameters of nanofibres vary in the range from 50 to 700 nm, while the diameter of nanofibres in individual nanofibrous layers in the direction of passage of the media being filtrated in each consecutive nanofibrous layer is decreasing with decreasing size of gaps for passage of media being filtrated between the nanofibres. The characteristic dimension of particles of low molecular substance or of low molecular substances in nanofibres of active nanofibrous layers 2, 21, 22 of couples L, L1, L2 of nanofibrous layers varies in the range from 5 to 100 nm. The particles of low molecular substance are deposited in polymer of nanofibre and reach up to the surface of nanofibre.

Filters according to the invention are designated especially for filtration of air and water.

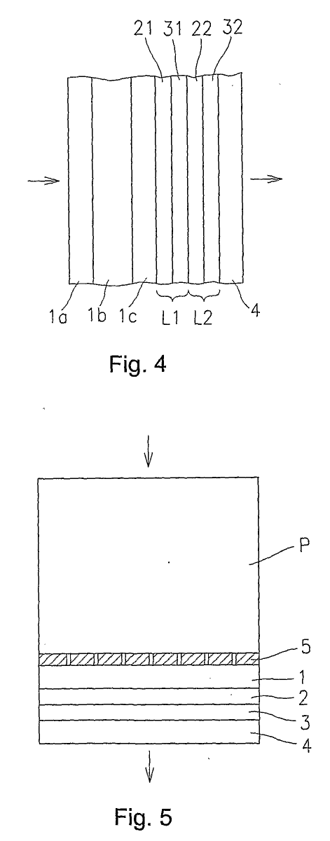

The air filters e.g. for cleaning of air in air conditioning circuits contain several filtration layers 1a, 1c created by textile fibres of various thickness, while in the direction of air passage in individual layers the diameter of fibres is gradually decreasing, and especially the size of gaps between fibres in textile layers is decreasing gradually. At the same time the endeavour is to preserve the maximum air permeability of filter and not to increase too much its resistance against air flow. Textile layers are frequently combined with at least one filtration layer of active carbon 1b. In the direction of air passage behind the filtration layers 1a, 1b, 1c there are arranged one or more couples of nanofibrous layers, in an example of embodiment according to the FIG. 4 there are illustrated two couples L1, L2 of nanofibrous layers, which are arranged in the same way as in the example of embodiment according to the FIG. 2. In the direction of air flow behind the textile filtration layer 1c there is arranged the active nanofibrous layer 21 of the first couple L1 of nanofibrous layers, behind which there is arranged the filtration nanofibrous layer 31 of the first couple L1 of nanofibrous layers. Behind the first couple L1 of nanofibrous layers there is arranged the second couple L2 of nanofibrous layers, whose active nanofibrous layer 22 is neighbouring with the filtration nanofibrous layer 31 of the first couple L1 of nanofibrous layers. The last nanofibrous layer is the filtration layer 32 of the second couple L2 of nanofibrous layers, behind which there is arranged the covering, carrying or supporting textile layer 4 in the direction of air flow. The first couple L1 of nanofibrous layers serves for catching and liquidation of bacteria, and the second couple L2 of nanofibrous layers serves for catching and liquidation of viruses.

Individual layers of filter may be bound or otherwise fixed with each other in some of known methods for increasing of filter consistency.

Upon air passage through the filter the mechanical impurities, especially the dust particles are caught on the textile filtration layers 1a, 1c and chemical substance, e.g. odours or harmful chemical substances are caught on the filtration layer 1b of active carbon. After the rough and fine dust particles are filtered off, the air is passing through the active nanofibrous layer 21 of the first couple L1 of nanofibrous layers, whose nanofibres containing the particles of at least one bactericidal low molecular substance, with advantage of metallic silver or quaternary ammonium salts, which kill or weaken bacteria caught by the filtration nanofibrous layer 31 of the first couple L1 of nanofibres being positioned behind the respective active nanofibrous layer 21. Upon passage of air through a second couple L2 being able to catch and liquidate viruses, these viruses are caught at the respective filtration nanofibrous layer 32 and are killed or weakened by the corresponding active nanofibrous layer 22.

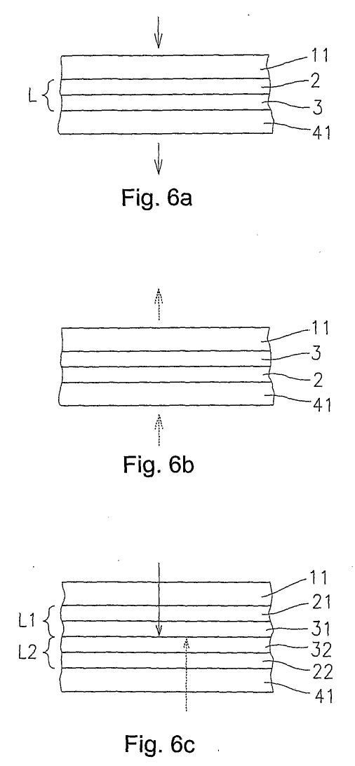

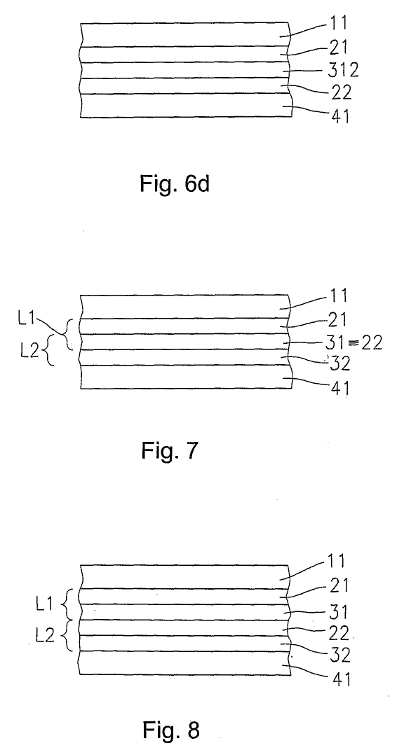

The FIG. 6 to 8 schematically illustrates a face screen for cleaning of air breathed in or breathed off by the user. This screen is formed of inner textile layer 41, which is produced e.g. by a melt-blown method from material, which has minimum effects to the skin as this layer adheres directly to the skin of the user. The face screen is equipped with known not illustrated means for fastening of screen to the face, securing of the screen against undesirable motion and with not illustrated known means for keeping tightness of the screen or its increasing, etc. The inner textile layer 41 may be produced also through another known method of production of non-woven textiles and even the use of woven or knitted textile is not excluded for it.

On the inner textile layer 4 there is deposited the filtration nanofibrous layer 3, which is formed of polymeric nanofibres produced through electrostatic spinning of the polymer solution, whose diameter lies in the range from 50 to 700 nanometers. Due to the fact that the task of this layer is to catch the finest particles of dust and biological impurities, the size of gaps for passage of air between individual nanofibres is smaller than the smallest biological or physical impurity, which should be caught. The size of gaps for catching of bacteria then varies to 300 nm, which means that the filtration layer is able to catch all bacteria, as their characteristic dimensions vary within the interval from 350 to 1000 nm. The size of gaps as well as diameters of fibres may up to a certain rate be influenced by the sort and composition of polymer solution being subject to spinning, by the design and arrangement of electrodes and of further technologically active parts of electrostatic spinning equipment.

In the direction of breathing in of air before the filtration nanofibrous layer 3 there is arranged an active nanofibrous layer 2, which is created by polymeric nanofibres produced through electrostatic spinning of polymer solution, which with advantage is the polyvinyl alcohol, polyurethane or polyamide. Nanofibres of active nanofibrous layer 2 have diameter from 50 to 750 nanometers and they contain particles of low molecular substance being effective against bacteria, which in the described example of embodiment is silver in metallic form, compounds of silver, e.g. salts of silver or quaternary ammonium salts. This active nanofibrous layer 2 after then relatively successfully destroys or distinctively weakens a broad spectrum of bacteria contained in breathed in air passing through active nanofibrous layer 2 and caught by the filtration nanofibrous layer 3.

In the direction of flow of breathed in air before an active nanofibrous layer 2 there is arranged outer textile layer 11, which is formed of any known textile, with advantage of a non woven textile. This layer serves first of all for filtration of rough particles of dust, hence to a certain extent for protection of a couple L of nanofibrous layers against clogging or damage. The direction of breathing in of air in the FIG. 6a is illustrated by unbroken arrows.

The face screen can be used for protection against spreading of biological impurities through breathing out, e.g. for protection of a patient against biological impurities breathed out by the surrounding persons, as shown in the FIG. 6b, where the direction of the breathed out air is shown by dashed-line arrows.

The filtration nanofibrous layer 3 of surgery face screen to prevent breathing out of biological impurities is arranged in the direction of breathing out before the outer textile layer 11 and between this filtration nanofibrous layer 3 and the inner textile layer 4 there is arranged the active nanofibrous layer 2, whose nanofibres contain particles of at least one low molecular bactericidal substance.

The face screen for catching and liquidation of biological impurities both at breathing in and breathing out is illustrated on the FIG. 6c, and it is a combination of both face screens described above and contains two couples L1, L2 of nanofibrous layers, which face one another by their filtration nanofibrous layers 31, 32.

Another execution of a face screen for catching and liquidation of biological impurities both at breathing in and at breathing out is illustrated in the FIG. 6d and it is a combination of both face screens described above and contains two couples L1, L2 of nanofibrous layers, which have one common filtration nanofibrous layer 312.

The breathed in air, whose direction is marked by an unbroken arrow, passes through the outer textile layer 11, active nanofibrous layer 21 and a filtration nanofibrous layer 31 of the first couple L1 of nanofibrous layers. Biological impurities which should be caught and liquidated are caught by the filtration nanofibrous layer 31 of the first couple L1 of nanofibrous layers and they are killed or weakened in the active nanofibrous layer 21 of the first couple L1 of nanofibrous layers.

The breathed out air, whose direction is shown in a dashed-line arrow, passes through the inner textile layer 41, through the active nanofibrous layer 22 and the filtration nanofibrous layer 32 of the second couple L2 of nanofibrous layers. Biological impurities which should be caught and liquidated are caught by the filtration nanofibrous layer 32 of the second couple L2 of nanofibrous layers and they are killed or weakened in the active nanofibrous layer 22 of the second couple L2 of nanofibrous layers.

The breathed out air further passes through the filtration nanofibrous layer 31 and the active nanofibrous layer 21 of the first couple L1 of nanofibrous layers, while it may release some breathed in biological impurities caught on the filtration nanofibrous layer 31 of the first couple L1 of nanofibrous layers. In such a case of releasing of biological impurity this biological impurity is already killed or weakened through acting of the active nanofibrous layer 22 of the first couple L1 of nanofibrous layers, while after releasing it still passes through this active nanofibrous layer 22 and the active low molecular substances in this layer continue to act upon it and before its releasing into the outer environment they weaken it further.

A similar process occurs at further breathing in of air after it passage through the first couple L1 of nanofibrous layers in case of release of earlier breathed out biological impurity caught on the nanofibrous layer 32 of the second couple L2 of nanofibrous layers, hence even at breathing in the air the reverted infection is prevented.

The face screen according to the FIG. 7 has been designed for cleaning of breathed in air and it contains two couples L1, L2 of nanofibrous layers arranged one after another, while the filtration nanofibrous layer 31 of the first couple L1 of nanofibrous layers is at the same time the active nanofibrous layer 22 of the second couple L2 of nanofibrous layers. The filtration possibilities and effects correspond to the filter according to the FIG. 3 described above. This face screen is designated for catching and liquidation of the whole range of bacteria and part of viruses.

The face screen according to the FIG. 8 is designated for cleaning of breathed in air and contains two couples L1, L2 of nanofibrous layers arranged one after another, as it was shown and described at embodiment according to the FIG. 2. Also this embodiment of the screen may serve both for catching and liquidation of bacteria and viruses.

The described face screens in embodiment according to the FIGS. 7 and 8 may be modified for a screen for cleaning of breathed out air or also for two-sided screen.

Filter according to the invention may be applied also at water cleaning. An example embodiment of water filter is schematically shown in the FIG. 5 and in the direction of filtrated water it contains several sand layers P lined up from the layer of the most rough particles up to a sand layer with very small grain size. In the direction of water flow through filter behind the sand filtration layers P at the illustrated embodiment there is arranged the distribution layer 5, behind which there is deposited a textile filtration layer 1, behind which there is an active nanofibrous layer 2 of polymeric nanofibres containing particles of at least one effective low molecular substance, with advantage of metallic silver or silver salts. This textile filtration layer 1 at the same time fulfils the function of protection of active nanofibrous layer 2 not to be damaged from the sand layers P. In the direction of water flow through the filter behind the active nanofibrous layer 2 there is arranged the filtration nanofibrous layer 3, and after it there is arranged the carrying or the supporting textile layer 4. The function of the water filter is in principle the same as the function of the air filter, which has been above described in a detailed way.

In all embodiments of filters of the described couple L, L1, L2, Li of nanofibrous layers the nanofibrous layers determined for catching and liquidation of bacteria have the surface weight 0.1 to 0.3 g/m², while the nanofibrous layers determined for catching and liquidation of viruses have the surface weight less than 0.1 g/m². As already stated above, the filtration nanofibrous layers have smaller surface weight than in the direction of passage of filtrated media before them positioned active nanofibrous layers. The nanofibrous layers of couples L, L1, L2, Li of nanofibrous layers may be produced separately or simultaneously, e.g. upon one passage through two sections of spinning device, when in one section there is produced e.g. the active nanofibrous layer of the corresponding couple, and in the second section the filtration nanofibrous layer of the corresponding couple. It is possible to produce also more couples of nanofibrous layers in various embodiments in one spinning device.

### INDUSTRIAL APPLICABILITY

The filter according to the invention is applicable for protection of health of persons or animals against biological impurities being present in the air and for cleaning of water from biological impurities being present in water.

### LIST OF REFERENTIAL MARKINGS

1 filtration layer
1a textile filtration layer
1b filtration layer of active carbon
1c textile filtration layer
   11 outer textile layer
   2 active nanofibrous layer
   21 active nanofibrous layer of the first couple of nanofibrous layers
22 active nanofibrous layer of the second couple of nanofibrous layers
   3 filtration nanofibrous layer
   31 filtration nanofibrous layer of the first couple of nanofibrous layers
32 filtration nanofibrous layer of the second couple of nanofibrous layers
312 filtration nanofibrous layer common for both couples of nanofibrous layers
4 carrying textile layer
L couple of nanofibrous layers
L1 first couple of nanofibrous layers
L2 second couple of nanofibrous layers
P sand filter

1. The filter for removing of physical and/or biological impurities from the filtrated media containing the textile fibres characterised by that it contains at least one couple (L) of nanofibrous layers, out of which in the direction of passage of the filtrated media the first nanofibrous layer is an active nanofibrous layer (2) formed of polymeric nanofibres containing particles of at least one low molecular substance active against the removed biological impurity or removed biological impurities, and the second nanofibrous layer is represented by the filtration nanofibrous layer (3) formed of polymeric nanofibres, while the size of gaps for passage of filtrated media between nanofibres of the filtration nanofibrous layer (3) is smaller than the size of gaps for passage of filtrated media between nanofibres of active nanofibrous layer (2) and smaller than the size of elements of biological impurity or biological impurities removed by means of this filtration nanofibrous layer (3).

2-24. (canceled)
